(19) United States
(12) Patent Application Publication
(10) Pub. No.: US 2007/0176391 A1
(43) Pub. Date: Aug. 2, 2007

(54) Power transmission system for wheeled personal transportation device

(76) Inventor: Prince Morowat, Aurora (CA)

Correspondence Address: SIM & MCBURNEY, 330 UNIVERSITY AVENUE, 6TH FLOOR, TORONTO, ON, M5G 1R7, CA

(21) Appl. No.: 11/313,652

(22) Filed: Dec. 22, 2005

(51) Int. Cl. B62M 1/02

(52) U.S. Cl. 280/260

(57) ABSTRACT

A power transmission system for a wheeled personal transportation device such as a bicycle comprises a sequence of at least three operably interconnected sets of gearwheels, a first set in the sequence for receiving rotational force and a last set in the sequence for transmitting rotational force for a driven wheel of the device. The first set and the last set each comprise user-selectable gearwheels. At least one intermediate set in the sequence comprises an input gearwheel subset and an output gearwheel subset, at least one of the input gearwheel subset and the output gearwheel subset comprising a plurality of user-selectable gearwheels. A frame for a personal transportation device comprises a base and a steering shaft on the base for supporting a steering column. Crank connection means are provided on the base for operably receiving a crank/pedal combination and an associated first set of user-selectable gearwheels. An upper-rearward extension extends from a rear of the base for operably receiving a second set of gearwheels comprising an input gearwheel subset and an output gearwheel subset. At least one of the input gearwheel subset and the output gearwheel subset comprise a plurality of user-selectable gearwheels. The frame further comprises a subextension associated with the upper-rearward extension for supporting a gearwheel-change mechanism associated with a respective one of the output gearwheel subset and the input gearwheel subset; and a lower-rearward extension extending from the rear of the base for supporting the driven wheel and a rotatable third set of gearwheels.

### FIELD OF THE INVENTION

The system disclosed herein relates generally to personal transportation devices and more specifically, to a power transmission system for a wheeled personal transportation device.

### BACKGROUND OF THE INVENTION

It is well known that a relatively large crank shaft sprocket wheel on wheeled transportation device such as a bicycle or geared tricycle when interconnected via chain with a small sprocket on a driven wheel will give a higher rotation speed than would be the case with a small crank shaft sprocket.

U.S. Pat. No. 1,360,032 (Schiffner) discloses a bicycle gearing system for increasing the speed for a given rotation of the pedal shaft without enlarging the crank shaft sprocket wheel. A single front sprocket on the crank shaft is connected by chain to a small sprocket on a second shaft. The small sprocket on the second shaft turns in unison with a larger sprocket on the second shaft, which is in turn connected by chain to a single small sprocket co-axial with the rear wheel. Numerous variants of the system proposed in the above-mentioned Schiffner patent have been proposed, for example in U.S. Pat. No. 1,535,714 (Burke), U.S. Pat. No. 5,102,155 (Chou) and U.S. Pat. No. 6,394,478 (Balajadia).

The prior art designs for increasing rotation speed of a driven wheel of a bicycle suffer drawbacks, such as limited or no available gear selection, configurations that in practice prove physically difficult or inconvenient for a user to employ, and great complexity.

It is an object of an aspect of this invention to provide a power transmission system for a personal transportation device such as a bicycle that overcomes some or all of these drawbacks in the prior art systems.

### SUMMARY OF THE INVENTION

According to one aspect, there is provided a power transmission system for a wheeled personal transportation device, comprising:

a sequence of at least three operably interconnected sets of gearwheels, a first set in the sequence for receiving rotational force and a last set in the sequence for transmitting rotational force for a driven wheel of the device, the first set and the last set each comprising user-selectable gearwheels;

at least one intermediate set in the sequence comprising an input gearwheel subset and an output gearwheel subset, at least one of the input gearwheel subset and the output gearwheel subset comprising a plurality of user-selectable gearwheels.

According to another aspect, there is provided a power transmission system for a wheeled personal transportation device, comprising:

a first set of user-selectable gearwheels for receiving rotational force;

a second set of gearwheels comprising an input gearwheel subset operably interconnected with the first set, and an output gearwheel subset, at least one of the input gearwheel subset and the output gearwheel subset comprising a plurality of user-selectable gearwheels; and

a third set of user-selectable gearwheels operably interconnected with the output gearwheel subset for transmitting rotational force for a driven wheel of the device.

According to yet another aspect, there is provided a frame for a personal transportation device, comprising:

a base;

a steering shaft on the base for supporting a steering column;

crank connection means on the base for operably receiving a crank/pedal combination and an associated first set of user-selectable gearwheels;

an upper-rearward extension extending from a rear of the base for operably receiving a second set of gearwheels comprising an input gearwheel subset and an output gearwheel subset, at least one of the input gearwheel subset and the output gearwheel subset comprising a plurality of user-selectable gearwheels;

a subextension associated with the upper-rearward extension for supporting a gearwheel-change mechanism associated with a respective one of the output gearwheel subset and the input gearwheel subset;

a lower-rearward extension extending from the rear of the base for supporting the driven wheel and a rotatable third set of gearwheels.

The system described herein provides numerous advantages. In particular, increased maximum theoretical speed is possible with the additional advantage of providing a small average mechanical ratio step size between gear changes. This feature provides the user with the option of reduced effort when traversing available speeds, and therefore improved efficiency. Furthermore, the disclosed frame configuration supports an intermediate user-selectable set of gearwheels to be kept separate from the user's legs during use of the personal transportation device.

### BRIEF DESCRIPTION OF THE DRAWINGS

Embodiments will now be described more fully with reference to the accompanying drawings, in which:

FIG. 1 is a side view of a bicycle incorporating a power transmission system and frame according to an embodiment of the invention;

FIG. 2 is a perspective view of an isolated power transmission system according to one embodiment of the invention;

FIG. 3 is a rear elevational view of an intermediate sprocket set having an input subset and an output subset of gearwheels, the output subset associated with a single derailleur;

FIG. 4 is a rear elevational view of an alternative intermediate sprocket set having an input subset and an output subset of sprockets, each associated with a respective derailleur;

FIG. 5 is a rear perspective view of an embodiment of a bicycle frame for supporting a power transmission system;

FIG. 6 is a top partial view of a bicycle with the transmission system distributed on both sides of the frame, according to one embodiment;

FIG. 7 is a graph illustrating theoretical speed v. sprocket combination for a fifty-four-speed bicycle with three sets of user-selectable sprockets;

FIG. 8 is a graph illustrating theoretical speed v. sprocket combination for a bicycle similar to that charted in FIG. 6 having three sets of sprockets, two of which are user-selectable;

FIG. 9 is a graph illustrating theoretical speed v. sprocket combination for an illustrative prior art eighteen-speed bicycle with two sets of user-selectable sprockets;

FIG. 10 is a graph illustrating theoretical speed v. sprocket combination for a thirty-six-speed bicycle with three sets of user-selectable sprockets;

FIG. 11 is a graph illustrating theoretical speed v. sprocket combination for a bicycle similar to that charted in FIG. 9 having three sets of sprockets, two of which are user-selectable;

FIG. 12 is a graph illustrating theoretical speed v. sprocket combination for an alternative thirty-six-speed bicycle with three sets of user-selectable sprockets;

FIG. 13 is a graph illustrating theoretical speed v. sprocket combination for a bicycle similar to that charted in FIG. 11 having three sets of sprockets, two of which are user-selectable;

FIG. 14 is a graph illustrating theoretical speed v. sprocket combination for a second alternative thirty-six-speed bicycle with three sets of user-selectable sprockets;

FIG. 15 is a graph illustrating theoretical speed v. sprocket combination for a bicycle similar to that charted in FIG. 13 having three sets of sprockets, two of which are user-selectable;

FIG. 16 is a graph illustrating theoretical speed v. sprocket combination for a fifty-four-speed bicycle with three sets of user-selectable sprockets;

FIG. 17 is a graph illustrating theoretical speed v. sprocket combination for a bicycle similar to that charted in FIG. 16 having three sets of sprockets, two of which are user-selectable;

FIG. 18 is a graph illustrating theoretical speed v. sprocket combination for a fifty-four-speed bicycle with three sets of user-selectable sprockets;

FIG. 19 is a graph illustrating theoretical speed v. sprocket combination for a bicycle similar to that charted in FIG. 18 having three sets of sprockets, two of which are user-selectable;

FIG. 20 is a graph illustrating theoretical speed v. sprocket combination for a fifty-four-speed bicycle with three sets of user-selectable sprockets;

FIG. 21 is a graph illustrating theoretical speed v. sprocket combination for a bicycle similar to that charted in FIG. 20 having three sets of sprockets, two of which are user-selectable;

FIG. 22 is a graph illustrating theoretical speed v. sprocket combination for a fifty-four-speed bicycle with three sets of user-selectable sprockets; and

FIG. 23 is a graph illustrating theoretical speed v. sprocket combination for a bicycle similar to that charted in FIG. 22 having three sets of sprockets, two of which are user-selectable.

### DETAILED DESCRIPTION OF THE EMBODIMENTS

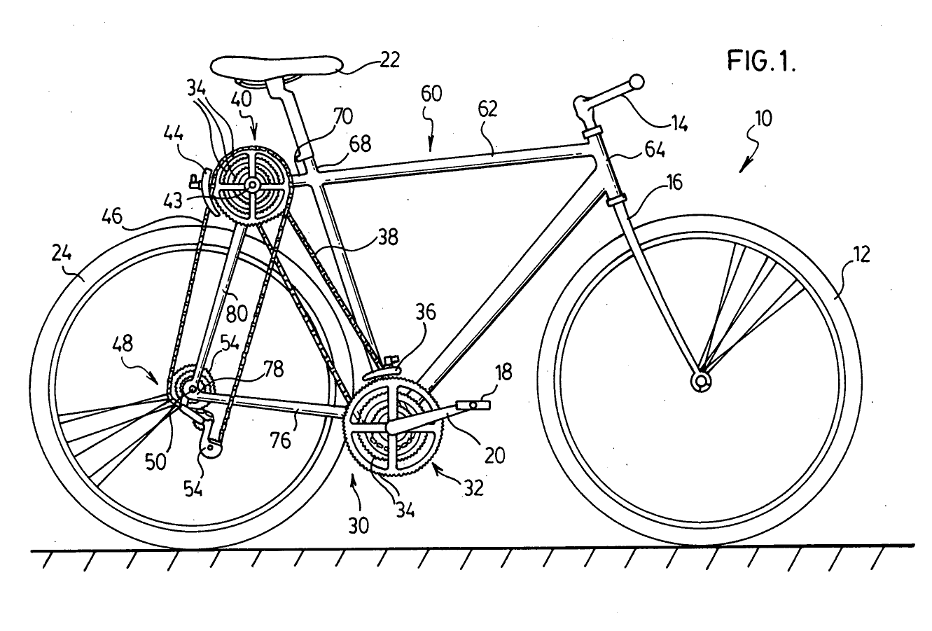

FIG. 1 is a side view of a bicycle 10 incorporating a power transmission system 30 mounted to a frame 60 of bicycle 10. Front wheel 12 is rotatably mounted to front wheel forks 16 of a steering column, which may rotated about a rotation axis relative to steering shaft 64 of frame 30 to which it is mounted, using handle bars 14. A seat 22 mounted to seat shaft 68 extends upwards from a base 62 of frame 60. Pedals 18 and a crank 20 form a combination for providing rotational power to the power transmission system 30. Power transmission system 30, in turn, transmits rotational power to the rear wheel 24 to which it is connected.

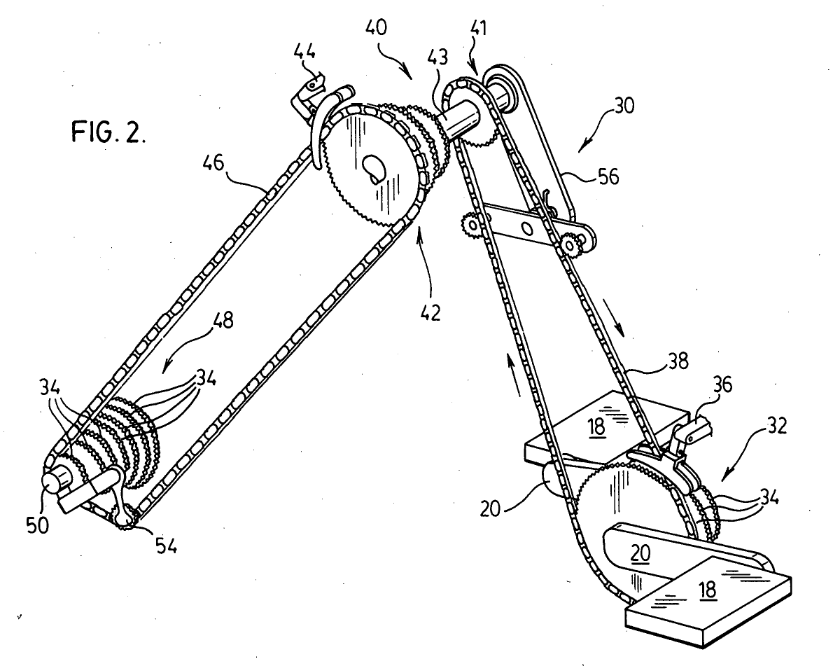

FIG. 2 is a perspective view of the power transmission system 30, shown without rear wheel 24 and frame 60 of bicycle 10 to which it would be mounted for operation. A first sprocket set 32 comprises multiple sprockets that rotate as a unit when force is applied to pedals 18 to turn crank 20. A first set derailleur 36 provides a user with the option of selecting which sprocket in first sprocket set 32 is coupled with a first chain 38. As is typical of multiple-speed bicycles, each of the sprockets in the first sprocket set respectively have a different diameter, and accordingly a different number of sprocket teeth.

First chain 38 is also coupled to a sprocket in a second sprocket set 40, providing an interconnection between first sprocket set 32 and second sprocket set 40. More specifically, first chain 38 is coupled to the single sprocket in an input subset 41 of second sprocket set 40. A tension is maintained in first chain 38 by spring tensioner 56 which comprises a bar with rotating sprockets that are in rolling contact with first chain 38. The bar of spring tensioner 56 is spring biased to put a small pressure on first chain 38 via the rotating sprockets of spring tensioner 56 when smaller sprockets are employed in first sprocket set 32. Where a larger sprocket is to be employed in first sprocket set 32, the bar of spring tensioner 56 is able to twist against its spring bias by the increased tension of first chain 38 around the larger sprocket, so as to accommodate for the inherent additional tension from contact of first chain 38 with the larger sprocket.

When input subset 41 receives force from first sprocket set 32 with which it is interconnected through first chain 38, output subset 44 is caused to rotate by virtue of second axle 43. An output subset derailleur 45 provides a user with the option of selecting which sprocket in output subset 42 of second sprocket set 40 is coupled with a second chain 46. Output subset derailleur 44 is arranged with respect to the input subset 41 and output subset 42 to prevent first chain 38 from interfering with second chain 46 during operation.

The sprockets in the output subset 42 of second sprocket set 40 respectively have a different diameter, and accordingly a different number of sprocket teeth. Depending on a designer's choice, the single sprocket in input subset 41 may have the same or a different diameter and number of sprocket teeth as one of the sprockets in output subset 42.

Second chain 46 is also coupled to a sprocket in a third sprocket set 48, providing an interconnection between second sprocket set 40 and third sprocket set 48. When third sprocket set 48 receives force from output subset 42 with which it is interconnected by second chain 46, third sprocket set 48 rotates about the axis of third axle 50, which in turn causes rear wheel 24 to rotate.

A third set derailleur/tensioner 54 provides a user with the option of selecting which sprocket in third sprocket set 48 is coupled with second chain 46. The adjustable derailleur/tensioner 54 also ensures that second chain 46 remains taut but still moveable between sprocket combinations.

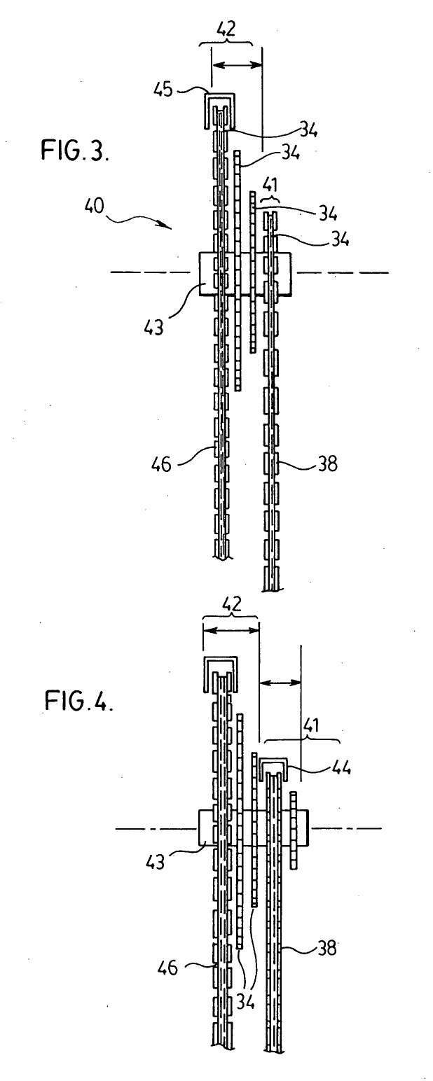

FIG. 3 is a rear elevational view of the second sprocket set 40 with input subset 41 and output subset 42. Three sprockets in output subset 42 are selectable by a user with the output subset derailleur 45. First chain 38 remains on the single sprocket in input subset 41.

FIG. 4 is a rear elevational view of an alternative second sprocket set 40 with input subset of sprockets 41 and output subset of sprockets 42, where input subset of sprockets 41 has two user-selectable sprockets. An input subset derailleur 44 provides a user with the option of selecting which sprocket in input subset 41 is coupled with first chain 38. The provision of an additional sprocket selection provides the power transmission system 30 with twice the number of user-selectable sprocket combinations. The input subset 41 and output subset 42 may be spaced apart for the purpose of partly straddling the rear wheel. Such a design choice would be based on the type and/or model of bicycle and the associated rear wheel diameter, tire width, and other such dimensions.

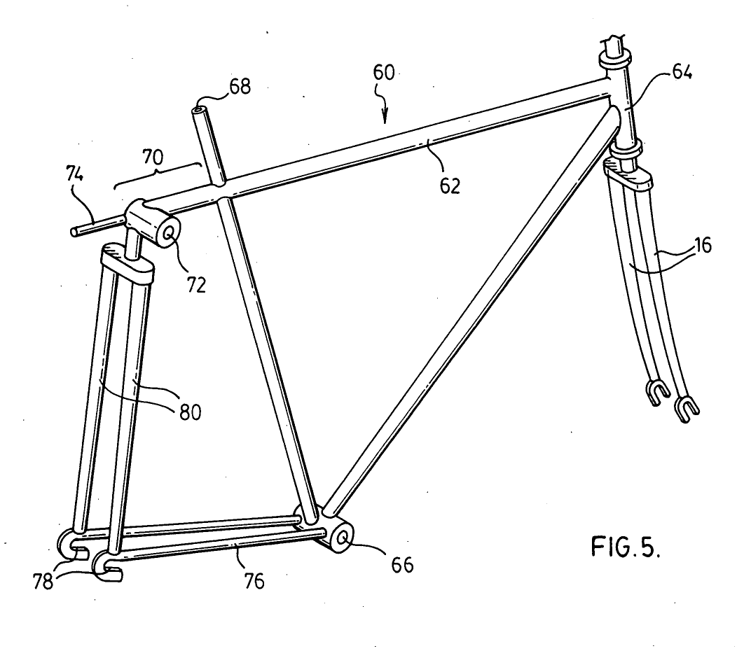

FIG. 5 is a rear perspective view of the bicycle frame 60 of FIG. 1, shown connected with the steering column including front forks 16 but without front wheel 12, rear wheel 24 and power transmission system 30 which would be normally connected for operation. Base 62 of frame 60 connects steering shaft 64 to first sprocket set shaft 66 and seat shaft 68. First sprocket set shaft receives an axle of crank 20 for rotatably mounting pedals 18, crank 20 and first sprocket set 32 of power transmission system 30.

An upper rearward extension 70 extends from base 62 just behind seat shaft 68, and includes a second sprocket set shaft 72 for receiving second axle 43 of second sprocket set 40. A subextension 74 extends still further rearward from second sprocket shaft 72, in order to provide a mount for input derailleur 44 and/or output derailleur 45. Advantageously, the location of upper rearward extension 70 behind seat shaft 68 ensures that second sprocket set 40, input and/or output derailleurs 44,45 are out of the way of a user's legs during operation.

Rear wheel forks 80 are spaced to straddle rear wheel 24, and extend downwardly from upper rearward extension 70 to meet with a lower rearward extension 76. Lower rearward extension includes a mount 78 for mounting an axle of rear wheel 24 and third sprocket set 48 using appropriate hardware (not shown).

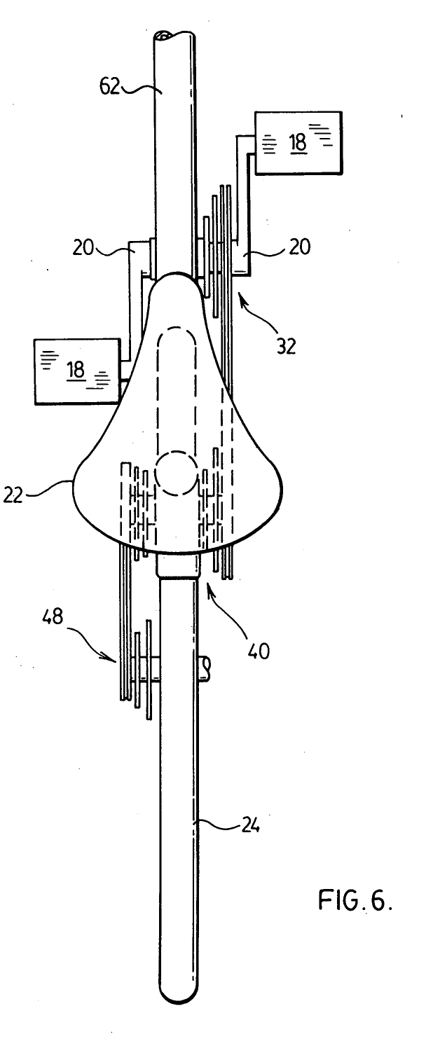

FIG. 6 is a top partial view of a bicycle with the transmission system distributed on both sides of the frame, according to one embodiment. According to this embodiment, which is compatible with the frame 60 shown in FIG. 5, first sprocket set 32, first chain 38 and input subset 41 of second sprocket set 40 are positioned substantially on the right side of frame 60. Second axle 43 spans the width of frame 60 so as to cause output subset 42 of second sprocket set 32 to be positioned substantially on the left side of frame 60 from input subset 41. Second chain 46 and third sprocket set 48 are also substantially disposed on the left side of frame 60. With this configuration, better weight balance of bicycle 10 is achieved. It will be understood that a mirror-image configuration, wherein the first sprocket set 32 is on the left side and the third sprocket set 48 is on the right side, is possible. It will also be understood that the largest sprocket in a sprocket set may be the farthest away from the associated wheel or frame, or the closest to the associated wheel or frame. For example, in FIG. 6 the largest sprocket in the third set 48 is closest to the rear wheel 24 but a designer may arrange the sprockets such that the largest sprocket in the third set 48 is farthest from rear wheel 24 and the sprockets progressively get smaller towards rear wheel 24.

Table 1 summarizes a configuration of the embodiment of the power transmission system 30 shown in FIG. 2, in which first sprocket set 32 has three user-selectable sprockets, input subset 41 of second sprocket set 40 has a single sprocket, output subset 42 of second sprocket set 40 has three user-selectable sprockets, and third sprocket set 48 has six user-selectable sprockets. The number of selectable sprocket combinations is 54.

TABLE 1

| | | |
|---|---|---|
| First Set | Second Set | Third Set |

| | | | | | |
|---|---|---|---|---|---|
| #1 | 48 teeth | Input | 14 | #1 | 28 teeth |
| #2 | 38 teeth | Output #1 | 48 | #2 | 24 teeth |
| #3 | 28 teeth | Output #2 | 38 | #3 | 21 teeth |
| | | Output #3 | 28 | #4 | 18 teeth |
| | | | | #5 | 16 teeth |
| | | | | #6 | 14 teeth |

Table 2 summarizes the speed ratios and theoretical speeds possible with the 54-speed configuration of Table 1, given a rear wheel outer diameter of 26″, and a maximum efficiency cadence of 80 rpm at the pedals.

TABLE 2

| | # | | # | Third | # | | Speed |
|---|---|---|---|---|---|---|---|
| First set | Teeth | Second Set | Teeth | Set | Teeth | Ratio | (mph) |
| [symbol] | [symbol] | [symbol] | [symbol] | #1 | 28 | 1:5.88 | 36.37 |
| | | | | #2 | 24 | 1:6.86 | 42.43 |
| | | | | #3 | 21 | 1:7.84 | 48.49 |
| | | | | #4 | 18 | 1:9.14 | 56.58 |
| | | | | #5 | 16 | 1:10.29 | 63.65 |
| | | | | [symbol] | [symbol] | [symbol] | [symbol] |
| | | Output #2 | 38 | #1 | 28 | 1:4.65 | 28.79 |
| | | | | #2 | 24 | 1:5.43 | 33.59 |
| | | | | #3 | 21 | 1:6.20 | 38.39 |
| | | | | #4 | 18 | 1:7.24 | 44.79 |
| | | | | #5 | 16 | 1:8.14 | 50.39 |
| | | | | #6 | 14 | 1:9.31 | 57.59 |
| | | Output #3 | 28 | #1 | 28 | 1:3.43 | 21.22 |
| | | | | #2 | 24 | 1:4.00 | 24.75 |
| | | | | #3 | 21 | 1:4.57 | 28.29 |
| | | | | #4 | 18 | 1:5.33 | 33.00 |
| | | | | #5 | 16 | 1:6.00 | 37.13 |
| | | | | #6 | 14 | 1:6.86 | 42.43 |
| #2 | 38 | Output #1 | 48 | #1 | 28 | 1:4.65 | 28.79 |
| | | | | #2 | 24 | 1:5.43 | 33.59 |
| | | | | #3 | 21 | 1:6.20 | 38.39 |
| | | | | #4 | 18 | 1:7.24 | 44.79 |
| | | | | #5 | 16 | 1:8.14 | 50.39 |
| | | | | #6 | 14 | 1:9.31 | 57.59 |
| | | Output #2 | 38 | #1 | 28 | 1:3.68 | 22.79 |
| | | | | #2 | 24 | 1:4.30 | 26.59 |
| | | | | #3 | 21 | 1:4.91 | 30.39 |
| | | | | #4 | 18 | 1:5.73 | 35.46 |
| | | | | #5 | 16 | 1:6.45 | 39.89 |
| | | | | #6 | 14 | 1:7.37 | 45.59 |
| | | Output #3 | 28 | #1 | 28 | 1:2.71 | 16.80 |
| | | | | #2 | 24 | 1:3.17 | 19.60 |
| | | | | #3 | 21 | 1:3.62 | 22.39 |
| | | | | #4 | 18 | 1:4.22 | 26.13 |
| | | | | #5 | 16 | 1:4.75 | 29.39 |
| | | | | #6 | 14 | 1:5.43 | 33.59 |
| #3 | 28 | Output #1 | 48 | #1 | 28 | 1:3.43 | 21.22 |
| | | | | #2 | 24 | 1:4.00 | 24.75 |
| | | | | #3 | 21 | 1:4.57 | 28.29 |
| | | | | #4 | 18 | 1:5.33 | 33.00 |
| | | | | #5 | 16 | 1:6.00 | 37.13 |
| | | | | #6 | 14 | 1:6.86 | 42.43 |
| | | Output #2 | 38 | #1 | 28 | 1:2.71 | 16.80 |
| | | | | #2 | 24 | 1:3.17 | 19.60 |
| | | | | #3 | 21 | 1:3.62 | 22.39 |
| | | | | #4 | 18 | 1:4.22 | 26.13 |
| | | | | #5 | 16 | 1:4.75 | 29.39 |
| | | | | #6 | 14 | 1:5.43 | 33.59 |
| | | Output #3 | 28 | #1 | 28 | 1:2.00 | 12.38 |
| | | | | #2 | 24 | 1:2.33 | 14.44 |
| | | | | #3 | 21 | 1:2.67 | 16.50 |
| | | | | #4 | 18 | 1:3.11 | 19.25 |
| | | | | #5 | 16 | 1:3.50 | 21.66 |
| | | | | #6 | 14 | 1:4.00 | 24.75 |

As can be seen, with the configuration of Table 1, a maximum theoretical speed of 72.74 miles per hour is possible, with 54 selectable combinations of sprockets, yielding 33 unique ratios from 2.00 to 11.76. Thus, the average ratio step size is (11.76−2.00)/33=0.295. It will be understood that the maximum theoretical speed calculation has been provided for illustration without factoring mechanical and surface friction, air drag and the like.

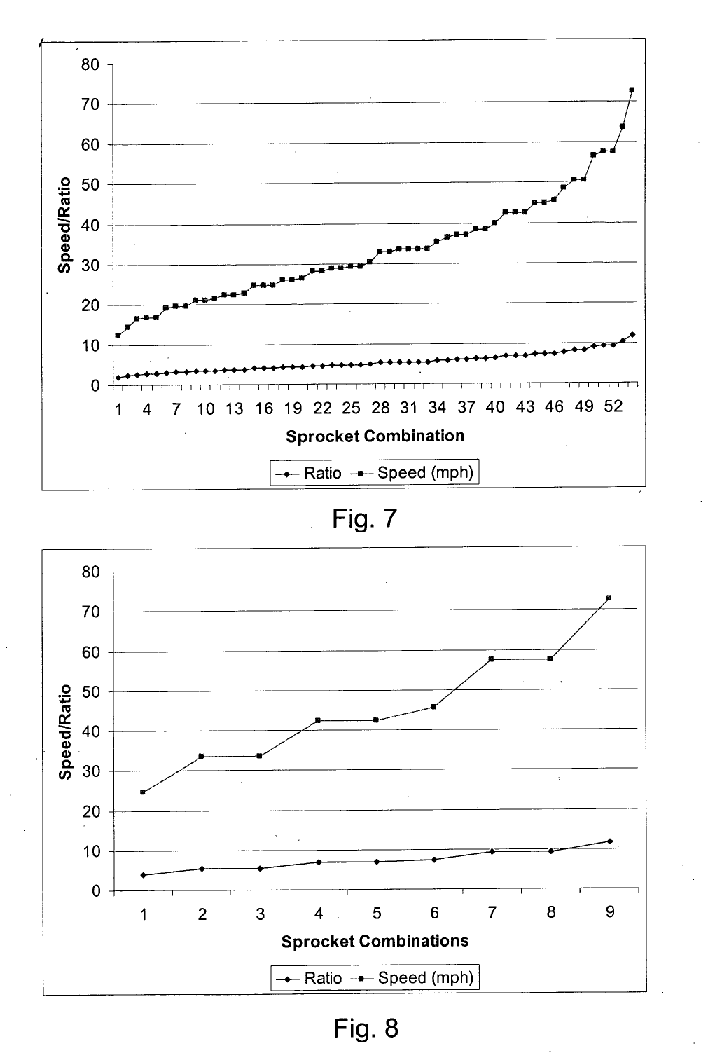

FIG. 7 is a graph illustrating theoretical speed v. sprocket combination for the 54-speed bicycle configuration of Table 1. It is advantageous to maintain a low average mechanical ratio step size so that a user can experience a comfortable transition from low to high speeds. It has been found that prior art power transmission systems for achieving higher speeds with three or more sets of gearwheels are particularly disadvantageous in this regard. This is because all ratios are effectively amplified with the addition of the third unselectable sprocket, accordingly amplifying the ratio step size and making the power transmission system increasing difficult to use across the range of speeds. As a result, with these prior art systems, a user must tolerate providing greater effort for traversing the available speeds, and diminished efficiency while attempting to achieve maximum speed.

FIG. 8 shows a graph illustrating theoretical speed v. sprocket combination for a power transmission system having the first and second sets of user-selectable gearwheels identical to the configuration of Table 1, and the third set fixed on sprocket #6. In this case, the theoretical maximum achievable speed is the same. However, it can be seen in the graph of FIG. 8 that the smaller incremental ratios are not available to the user. Thus, the average ratio step size is high at (11.76−4.00)/9=0.862.

In order to illustrate the operation of the invention relative to the prior art, Table 3 shows a typical prior art 18-speed power transmission system configuration, having three user-selectable sprockets in a first set associated with the pedal and driving sprockets, and six user-selectable sprockets in a second set associated with the driven wheel.

TABLE 3
Prior Art.

| | | |
|---|---|---|
| First Set | Second Set | # Teeth |

| | | | |
|---|---|---|---|
| #1 | 48 teeth | #1 | 28 teeth |
| #2 | 38 teeth | #2 | 24 teeth |
| #3 | 28 teeth | #3 | 21 teeth |
| | | #4 | 18 teeth |
| | | #5 | 16 teeth |
| | | #6 | 14 teeth |

Table 4 summarizes rotation ratios and theoretical achievable speeds with the 18-speed power transmission system configuration shown in Table 3, in which driven wheel outer diameter is 26″, and a maximum efficiency cadence at the first set is 80 rpm.

TABLE 4
Prior Art.

| | | | | | Speed |
|---|---|---|---|---|---|
| First Set | #Teeth | Second Set | #Teeth | Ratio | (mph) |
| [symbol] | [symbol] | #1 | 28 | 1:1.71 | 10.61 |
| | | #2 | 24 | 1:2.00 | 12.38 |
| | | #3 | 21 | 1:2.29 | 14.14 |
| | | #4 | 18 | 1:2.67 | 16.50 |
| | | #5 | 16 | 1:3.00 | 18.56 |
| | | [symbol] | [symbol] | [symbol] | [symbol] |
| #2 | 38 | #1 | 28 | 1:1.36 | 8.40 |
| | | #2 | 24 | 1:1.58 | 9.80 |
| | | #3 | 21 | 1:1.81 | 11.20 |
| | | #4 | 18 | 1:2.11 | 13.06 |
| | | #5 | 16 | 1:2.38 | 14.70 |
| | | #6 | 14 | 1:2.71 | 16.80 |
| #3 | 28 | #1 | 28 | 1:1.00 | 6.19 |
| | | #2 | 24 | 1:1.17 | 7.22 |
| | | #3 | 21 | 1:1.33 | 8.25 |
| | | #4 | 18 | 1:1.56 | 9.63 |
| | | #5 | 16 | 1:1.75 | 10.83 |
| | | #6 | 14 | 1:2.00 | 12.38 |

The maximum theoretical speed achievable with the 18-speed configuration shown in Table 3 is 21.22 miles per hour, achievable using the #1 gearwheel in the first set, and the #6 gearwheel in the second set to provide the maximum available ratio. In total, there are 18 selectable combinations of sprockets, yielding 17 unique input/output rotation ratios from 1.00 to 3.43. The average ratio step size is therefore: (3.43−1.00)/17=0.142.

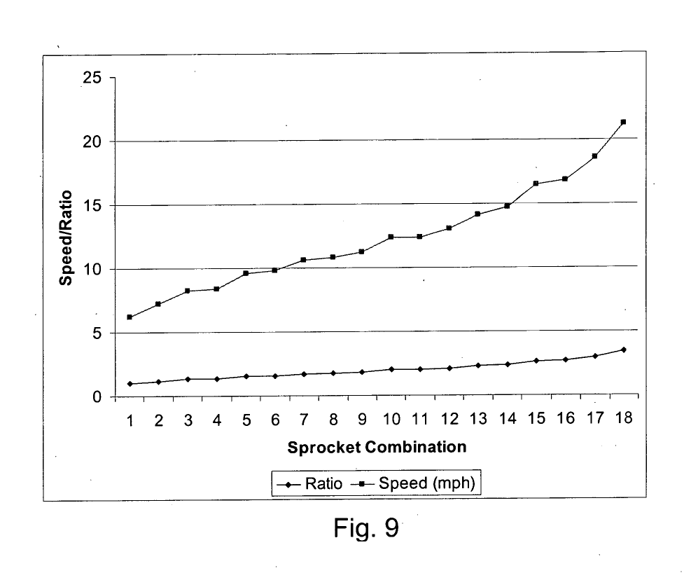

FIG. 9 is a graph illustrating theoretical maximum speed v. sprocket combination for the 18-speed bicycle configuration of Table 3. It can be seen that there is a low average mechanical gear ratio with this configuration.

Table 5 shows a 36-speed transmission configuration according to an alternative embodiment of the invention, in which first sprocket set 32 has three user-selectable sprockets, input subset 41 of second sprocket set 40 has two user-selectable sprockets, output subset 42 of second sprocket set 40 a single sprocket with 28 teeth, and third sprocket set 48 has six user-selectable sprockets. The number of selectable sprocket combinations is 36.

TABLE 5

| | | |
|---|---|---|
| First Set | Second Set | Third Set |

| | | | | | |
|---|---|---|---|---|---|
| #1 | 48 teeth | Input #1 | 14 | #1 | 28 teeth |
| #2 | 38 teeth | Input #2 | 16 | #2 | 24 teeth |
| #3 | 28 teeth | Output | 28 | #3 | 21 teeth |
| | | | | #4 | 18 teeth |
| | | | | #5 | 16 teeth |
| | | | | #6 | 14 teeth |

Table 6 summarizes the rotation ratios and theoretical achievable speeds with the 36-speed transmission configuration shown in Table 5, in which driven wheel outer diameter is 26″, and a maximum efficiency cadence at the first set is 80 rpm.

TABLE 6

| | # | | # | Thrid | # | | Speed |
|---|---|---|---|---|---|---|---|
| First set | Teeth | Second Set | Teeth | Set | Teeth | Ratio | (mph) |
| [symbol] | [symbol] | [symbol] | [symbol] | #1 | 28 | 1:3.43 | 21.22 |
| | | | | #2 | 24 | 1:4.00 | 24.75 |
| | | | | #3 | 21 | 1:4.57 | 28.29 |
| | | | | #4 | 18 | 1:5.33 | 33.00 |
| | | | | #5 | 16 | 1:6.00 | 37.13 |
| | | | | [symbol] | [symbol] | [symbol] | [symbol] |
| | | Input #2 | 16 | #1 | 28 | 1:3.00 | 18.56 |
| | | | | #2 | 24 | 1:3.50 | 21.66 |
| | | | | #3 | 21 | 1:4.00 | 24.75 |
| | | | | #4 | 18 | 1:4.67 | 28.88 |
| | | | | #5 | 16 | 1:5.25 | 32.49 |
| | | | | #6 | 14 | 1:6.00 | 37.13 |
| #2 | 38 | Input #1 | 14 | #1 | 28 | 1:2.71 | 16.80 |
| | | | | #2 | 24 | 1:3.17 | 19.60 |
| | | | | #3 | 21 | 1:3.62 | 22.39 |
| | | | | #4 | 18 | 1:4.22 | 26.13 |
| | | | | #5 | 16 | 1:4.75 | 29.39 |
| | | | | #6 | 14 | 1:5.43 | 33.59 |
| | | Input #2 | 16 | #1 | 28 | 1:2.38 | 14.70 |
| | | | | #2 | 24 | 1:2.77 | 17.15 |
| | | | | #3 | 21 | 1:3.17 | 19.60 |
| | | | | #4 | 18 | 1:3.69 | 22.86 |
| | | | | #5 | 16 | 1:4.16 | 25.72 |
| | | | | #6 | 14 | 1:4.75 | 29.39 |
| #3 | 28 | Input #1 | 14 | #1 | 28 | 1:2.00 | 12.38 |
| | | | | #2 | 24 | 1:2.33 | 14.44 |
| | | | | #3 | 21 | 1:2.67 | 16.50 |
| | | | | #4 | 18 | 1:3.11 | 19.25 |
| | | | | #5 | 16 | 1:3.50 | 21.66 |
| | | | | #6 | 14 | 1:4.00 | 24.75 |
| | | Input #2 | 16 | #1 | 28 | 1:1.75 | 10.83 |
| | | | | #2 | 24 | 1:2.04 | 12.63 |
| | | | | #3 | 21 | 1:2.33 | 14.44 |
| | | | | #4 | 18 | 1:2.72 | 16.85 |
| | | | | #5 | 16 | 1:3.06 | 18.95 |
| | | | | #6 | 14 | 1:3.50 | 21.66 |

As can be seen, with the configuration of Table 5, a maximum theoretical speed of 42.43 miles per hour is possible, with 36 selectable combinations of sprockets, yielding 28 unique ratios from 1.75 to 6.86. Thus, the average step size is (6.86−1.75)/28=0.182. While this is a greater step size than that available with the 18-speed bicycle example above, the theoretical maximum achievable speed is significantly increased over the prior art 18-speed bicycle.

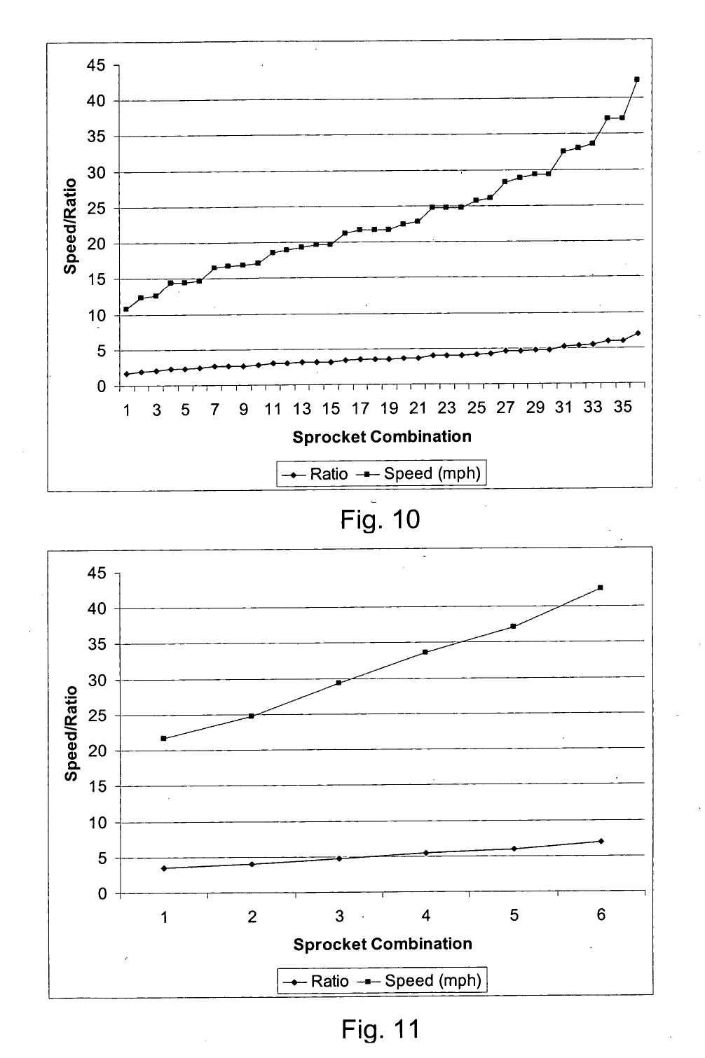

FIG. 10 is a graph illustrating theoretical speed v. sprocket combination for the 36-speed bicycle configuration of Table 5.

FIG. 11 shows a graph illustrating theoretical speed v. sprocket combination for a power transmission system having the first and second sets of user-selectable sprockets identical to the configuration of Table 5, and the third set fixed on sprocket #6. In this case, the theoretical maximum achievable speed is the same. However, it can be seen in the graph of FIG. 11 the smaller incremental ratios are not available to the user, as there are only six selectable sprocket combinations. Thus, the average ratio step size is high at (6.86−3.50)/6=0.56.

Table 7 shows a 36-speed transmission configuration according to an alternative embodiment of the invention, in which first sprocket set 32 has three user-selectable sprockets, input subset 41 of second sprocket set 40 has two user-selectable sprockets, output subset 42 of second sprocket set 40 has a single sprocket, and third sprocket set 48 has six user-selectable sprockets. The number of selectable sprocket combinations is 36. The configuration is identical to that shown in Table 5, except that the output gearwheel in the second set has 38 teeth, instead of 28 teeth.

TABLE 7

| | | |
|---|---|---|
| First Set | Second Set | Thired Set |

| | | | | | |
|---|---|---|---|---|---|
| #1 | 48 teeth | Input #1 | 14 | #1 | 28 teeth |
| #2 | 38 teeth | Input #2 | 16 | #2 | 24 teeth |
| #3 | 28 teeth | Output | 38 | #3 | 21 teeth |
| | | | | #4 | 18 teeth |
| | | | | #5 | 16 teeth |
| | | | | #6 | 14 teeth |

Table 8 summarizes the speed ratios and theoretical speeds possible with the 36-speed configuration of Table 7, given a rear wheel outer diameter of 26″, and a maximum efficiency cadence of 80 rpm at the pedals.

TABLE 8

| | # | | # | Third | | | Speed |
|---|---|---|---|---|---|---|---|
| First Set | Teeth | Second Set | Teeth | Set | # Teeth | Ratio | (mph) |
| [symbol] | [symbol] | [symbol] | [symbol] | #1 | 28 | 1:4.65 | 28.79 |
| | | | | #2 | 24 | 1:5.43 | 33.59 |
| | | | | #3 | 21 | 1:6.20 | 38.39 |
| | | | | #4 | 18 | 1:7.24 | 44.79 |
| | | | | #5 | 16 | 1:8.14 | 50.39 |
| | | | | [symbol] | [symbol] | [symbol] | [symbol] |
| | | Input #2 | 16 | #1 | 28 | 1:4.07 | 25.19 |
| | | | | #2 | 24 | 1:4.75 | 29.39 |
| | | | | #3 | 21 | 1:5.43 | 33.59 |
| | | | | #4 | 18 | 1:6.33 | 39.19 |
| | | | | #5 | 16 | 1:7.13 | 32.49 |
| | | | | #6 | 14 | 1:8.14 | 50.39 |
| #2 | 38 | Input #1 | 14 | #1 | 28 | 1:3.68 | 22.79 |
| | | | | #2 | 24 | 1:4.30 | 26.59 |
| | | | | #3 | 21 | 1:4.91 | 30.39 |
| | | | | #4 | 18 | 1:5.73 | 35.46 |
| | | | | #5 | 16 | 1:6.45 | 39.89 |
| | | | | #6 | 14 | 1:7.37 | 45.59 |
| | | Input #2 | 16 | #1 | 28 | 1:3.22 | 19.95 |
| | | | | #2 | 24 | 1:3.76 | 23.27 |
| | | | | #3 | 21 | 1:4.30 | 26.59 |
| | | | | #4 | 18 | 1:5.01 | 31.03 |
| | | | | #5 | 16 | 1:5.64 | 34.90 |
| | | | | #6 | 14 | 1:6.45 | 39.89 |
| #3 | 28 | Input #1 | 14 | #1 | 28 | 1:2.71 | 16.80 |
| | | | | #2 | 24 | 1:3.17 | 19.60 |
| | | | | #3 | 21 | 1:3.62 | 22.39 |
| | | | | #4 | 18 | 1:4.22 | 26.13 |
| | | | | #5 | 16 | 1:4.75 | 29.39 |
| | | | | #6 | 14 | 1:5.43 | 33.59 |
| | | Input #2 | 16 | #1 | 28 | 1:2.38 | 14.70 |
| | | | | #2 | 24 | 1:2.77 | 17.15 |
| | | | | #3 | 21 | 1:3.17 | 19.60 |
| | | | | #4 | 18 | 1:3.69 | 22.86 |
| | | | | #5 | 16 | 1:4.16 | 25.72 |
| | | | | #6 | 14 | 1:4.75 | 29.39 |

As can be seen, with the configuration of Table 7, a maximum theoretical speed of 57.59 miles per hour is possible, with thirty-six selectable combinations of sprockets, yielding 28 unique ratios from 2.38 to 9.31. Thus, the average step size is (9.31−2.38)/28=0.248.

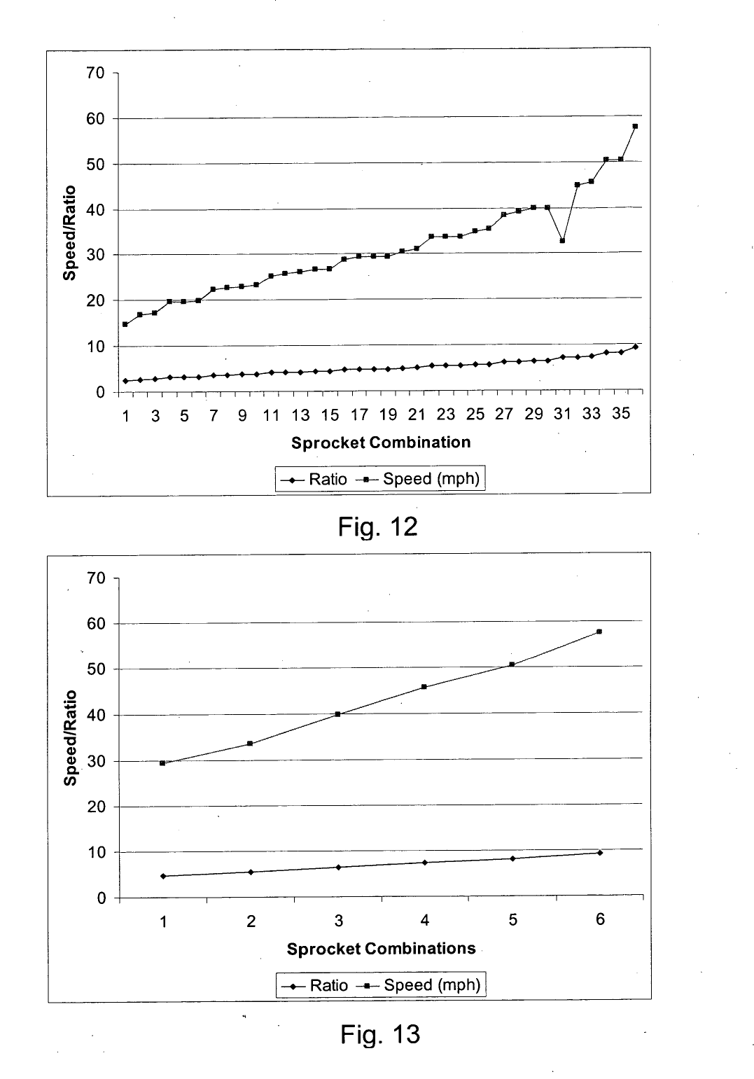

FIG. 12 is a graph illustrating theoretical speed v. sprocket combination for the 36-speed bicycle configuration of Table 7.

FIG. 13 shows a graph illustrating theoretical speed v. sprocket combination for a power transmission system having the first and second sets of user-selectable gearwheels identical to the configuration of Table 7, with the third set fixed on sprocket #6. In this case, the theoretical maximum achievable speed is the same. However, it can be seen in the graph of FIG. 13 that the smaller incremental ratios are not available to the user. Thus, the average ratio step size is (9.31−4.75)/6=0.76.

Table 9 shows a 36-speed transmission configuration according to an alternative embodiment of the invention, in which first sprocket set 32 has three user-selectable sprockets, input subset 41 of second sprocket set 40 has two user-selectable sprockets, output subset 42 of second sprocket set 40 has a single sprocket, and third sprocket set 48 has six user-selectable sprockets. The number of selectable sprocket combinations is 36. The configuration is identical to that shown in Table 5, except that the output gearwheel in the second set has 48 teeth, instead of 28 teeth.

TABLE 9

| | | |
|---|---|---|
| First Set | Second Set | Third Set |

| | | | | | |
|---|---|---|---|---|---|
| #1 | 48 teeth | Input #1 | 14 | #1 | 28 teeth |
| #2 | 38 teeth | Input #2 | 16 | #2 | 24 teeth |
| #3 | 28 teeth | Output | 48 | #3 | 21 teeth |
| | | | | #4 | 18 teeth |
| | | | | #5 | 16 teeth |
| | | | | #6 | 14 teeth |

Table 10 summarizes the speed ratios and theoretical speeds possible with the 36-speed configuration of Table 9, given a rear wheel outer diameter of 26″, and a maximum efficiency cadence of 80 rpm at the pedals.

TABLE 10

| | # | | # | Third | # | | Speed |
|---|---|---|---|---|---|---|---|
| First Set | Teeth | Second Set | Teeth | Set | Teeth | Ratio | (mph) |
| [symbol] | [symbol] | [symbol] | [symbol] | #1 | 28 | 1:5.88 | 36.37 |
| | | | | #2 | 24 | 1:6.86 | 42.43 |
| | | | | #3 | 21 | 1:7.84 | 48.49 |
| | | | | #4 | 18 | 1:9.14 | 56.58 |
| | | | | #5 | 16 | 1:10.29 | 63.65 |
| | | | | [symbol] | [symbol] | [symbol] | [symbol] |
| | | Input #2 | 16 | #1 | 28 | 1:5.14 | 31.82 |
| | | | | #2 | 24 | 1:6.00 | 37.13 |
| | | | | #3 | 21 | 1:6.86 | 42.43 |
| | | | | #4 | 18 | 1:8.00 | 49.50 |
| | | | | #5 | 16 | 1:9.00 | 55.69 |
| | | | | #6 | 14 | 1:10.29 | 63.65 |
| #2 | 38 | Input #1 | 14 | #1 | 28 | 1:4.65 | 28.79 |
| | | | | #2 | 24 | 1:5.43 | 33.59 |
| | | | | #3 | 21 | 1:6.20 | 38.39 |
| | | | | #4 | 18 | 1:7.24 | 44.79 |
| | | | | #5 | 16 | 1:8.14 | 50.39 |
| | | | | #6 | 14 | 1:9.31 | 57.59 |
| | | Input #2 | 16 | #1 | 28 | 1:4.07 | 25.19 |
| | | | | #2 | 24 | 1:4.75 | 29.39 |
| | | | | #3 | 21 | 1:5.43 | 33.59 |
| | | | | #4 | 18 | 1:6.33 | 39.19 |
| | | | | #5 | 16 | 1:7.13 | 44.09 |
| | | | | #6 | 14 | 1:8.14 | 50.39 |
| #3 | 28 | Input #1 | 14 | #1 | 28 | 1:3.43 | 21.22 |
| | | | | #2 | 24 | 1:4.00 | 24.75 |
| | | | | #3 | 21 | 1:4.57 | 28.29 |
| | | | | #4 | 18 | 1:5.33 | 33.00 |
| | | | | #5 | 16 | 1:6.00 | 37.13 |
| | | | | #6 | 14 | 1:6.86 | 42.43 |
| | | Input #2 | 16 | #1 | 28 | 1:3.00 | 18.56 |
| | | | | #2 | 24 | 1:3.50 | 21.66 |
| | | | | #3 | 21 | 1:4.00 | 24.75 |
| | | | | #4 | 18 | 1:4.67 | 28.88 |
| | | | | #5 | 16 | 1:5.25 | 32.49 |
| | | | | #6 | 14 | 1:6.00 | 37.13 |

As can be seen, as with the configuration of Table 9, a maximum theoretical speed of 72.74 miles per hour is possible, with thirty-six selectable combinations of sprockets, yielding 28 unique ratios from 3.00 to 11.76. Thus, the average ratio step size is (11.76−3.00)/28=0.312.

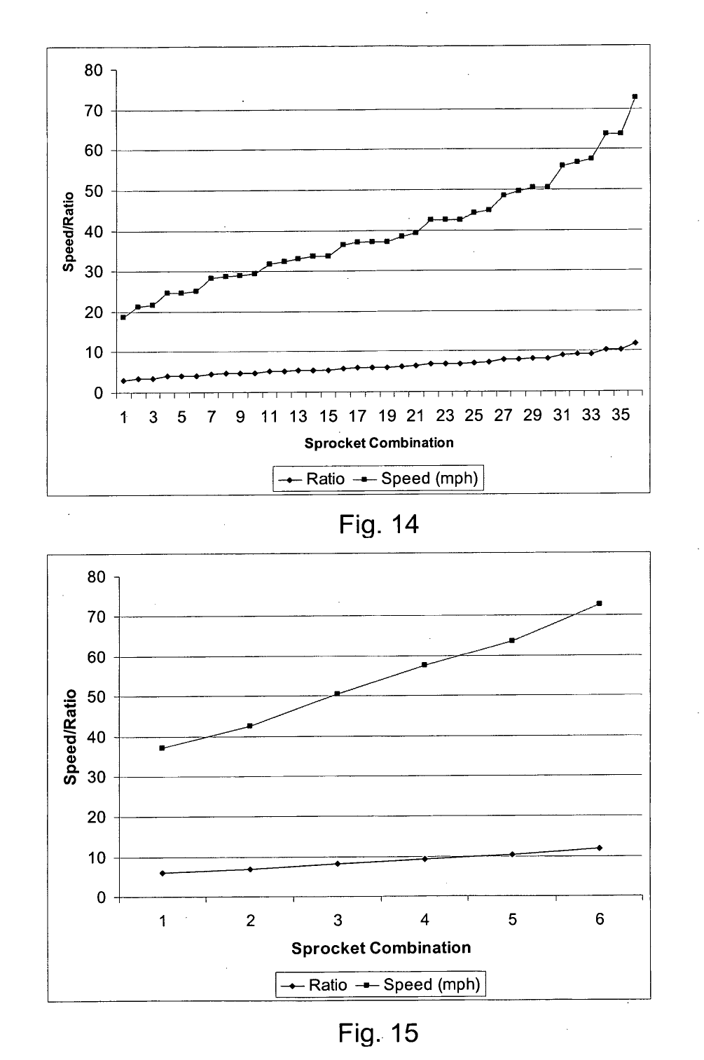

FIG. 14 is a graph illustrating theoretical speed v. sprocket combination for the 36-speed bicycle configuration of Table 9.

FIG. 15 shows a graph illustrating theoretical speed v. sprocket combination for a power transmission system having the first and second sets of user-selectable gearwheels identical to the configuration of Table 9, with the third set fixed on sprocket #6. In this case, the theoretical maximum achievable speed is the same. However, it can be seen in the graph of FIG. 15 that the smaller incremental ratios are not available to the user. Thus, the average ratio step size is (11.76−6.00)/6=0.96.

Table 11 summarizes a configuration of the embodiment of the power transmission system 30 shown in FIG. 2, in which first sprocket set 32 has three user-selectable sprockets, input subset 41 of second sprocket set 40 has a single sprocket, output subset 42 of second sprocket set 40 has three user-selectable sprockets, and third sprocket set 48 has six user-selectable sprockets. The number of selectable sprocket combinations is 54.

TABLE 11

| First Set | | Second Set | | Third Set | |
|---|---|---|---|---|---|
| #1 | 48 teeth | Input | 14 teeth | #1 | 28 teeth |
| #2 | 38 teeth | Output #1 | 48 teeth | #2 | 24 teeth |
| #3 | 28 teeth | Output #2 | 38 teeth | #3 | 21 teeth |
| | | OutPut #3 | 28 teeth | #4 | 18 teeth |
| | | | | #5 | 16 teeth |
| | | | | #6 | 14 teeth |

Table 12 summarizes the speed ratios and theoretical speeds possible with the 54-speed configuration of Table 11, given a rear wheel outer diameter of 26″, and 120 rpm at the pedals.

TABLE 12

| | # | | # | Third | # | | Speed |
|---|---|---|---|---|---|---|---|
| First Set | Teeth | Second Set | Teeth | Set | Teeth | Ratio | (mph) |
| [symbol] | [symbol] | [symbol] | [symbol] | #1 | 28 | 1:5.88 | 54.56 |
| | | | | #2 | 24 | 1:6.86 | 63.65 |
| | | | | #3 | 21 | 1:7.84 | 72.74 |
| | | | | #4 | 18 | 1:9.14 | 84.86 |
| | | | | #5 | 16 | 1:10.29 | 95.47 |
| | | | | [symbol] | [symbol] | [symbol] | [symbol] |
| | | Output #2 | 38 | #1 | 28 | 1:4.65 | 43.19 |
| | | | | #2 | 24 | 1:5.43 | 50.39 |
| | | | | #3 | 21 | 1:6.20 | 57.59 |
| | | | | #4 | 18 | 1:7.24 | 67.18 |
| | | | | #5 | 16 | 1:8.14 | 75.58 |
| | | | | #6 | 14 | 1:9.31 | 86.38 |
| | | Output #3 | 28 | #1 | 28 | 1:3.43 | 31.82 |
| | | | | #2 | 24 | 1:4.00 | 37.13 |
| | | | | #3 | 21 | 1:4.57 | 42.43 |
| | | | | #4 | 18 | 1:5.33 | 49.50 |
| | | | | #5 | 16 | 1:6.00 | 55.69 |
| | | | | #6 | 14 | 1:6.86 | 63.65 |
| #2 | 38 | Output #1 | 48 | #1 | 28 | 1:4.65 | 43.19 |
| | | | | #2 | 24 | 1:5.43 | 50.39 |
| | | | | #3 | 21 | 1:6.20 | 57.59 |
| | | | | #4 | 18 | 1:7.24 | 67.18 |
| | | | | #5 | 16 | 1:8.14 | 75.58 |
| | | | | #6 | 14 | 1:9.31 | 86.38 |
| | | Output #2 | 38 | #1 | 28 | 1:3.68 | 34.19 |
| | | | | #2 | 24 | 1:4.30 | 39.89 |
| | | | | #3 | 21 | 1:4.91 | 45.59 |
| | | | | #4 | 18 | 1:5.73 | 53.19 |
| | | | | #5 | 16 | 1:6.45 | 59.84 |
| | | | | #6 | 14 | 1:7.37 | 68.38 |
| | | Output #3 | 28 | #1 | 28 | 1:2.71 | 25.19 |
| | | | | #2 | 24 | 1:3.17 | 29.39 |
| | | | | #3 | 21 | 1:3.62 | 33.59 |
| | | | | #4 | 18 | 1:4.22 | 39.19 |
| | | | | #5 | 16 | 1:4.75 | 44.09 |
| | | | | #6 | 14 | 1:5.43 | 50.39 |
| #3 | 28 | Output #1 | 48 | #1 | 28 | 1:3.43 | 31.82 |
| | | | | #2 | 24 | 1:4.00 | 37.13 |
| | | | | #3 | 21 | 1:4.57 | 42.43 |
| | | | | #4 | 18 | 1:5.33 | 49.50 |
| | | | | #5 | 16 | 1:6.00 | 55.69 |
| | | | | #6 | 14 | 1:6.86 | 63.65 |
| | | Output #2 | 38 | #1 | 28 | 1:2.71 | 25.19 |
| | | | | #2 | 24 | 1:3.17 | 29.39 |
| | | | | #3 | 21 | 1:3.62 | 33.59 |
| | | | | #4 | 18 | 1:4.22 | 39.19 |
| | | | | #5 | 16 | 1:4.75 | 44.09 |
| | | | | #6 | 14 | 1:5.43 | 50.39 |
| | | Output #3 | 28 | #1 | 28 | 1:2.00 | 18.56 |
| | | | | #2 | 24 | 1:2.33 | 21.66 |
| | | | | #3 | 21 | 1:2.67 | 24.75 |
| | | | | #4 | 18 | 1:3.11 | 28.88 |
| | | | | #5 | 16 | 1:3.50 | 32.49 |
| | | | | #6 | 14 | 1:4.00 | 37.13 |

As can be seen, with the configuration of Table 11, where an increased rpm of 120 is achieved by the user, a maximum theoretical speed of 109.11 miles per hour is possible, with 54 selectable combinations of sprockets, yielding 33 unique ratios from 2.00 to 11.76. Thus, the average ratio step size is (11.76−2.00)/33=0.295.

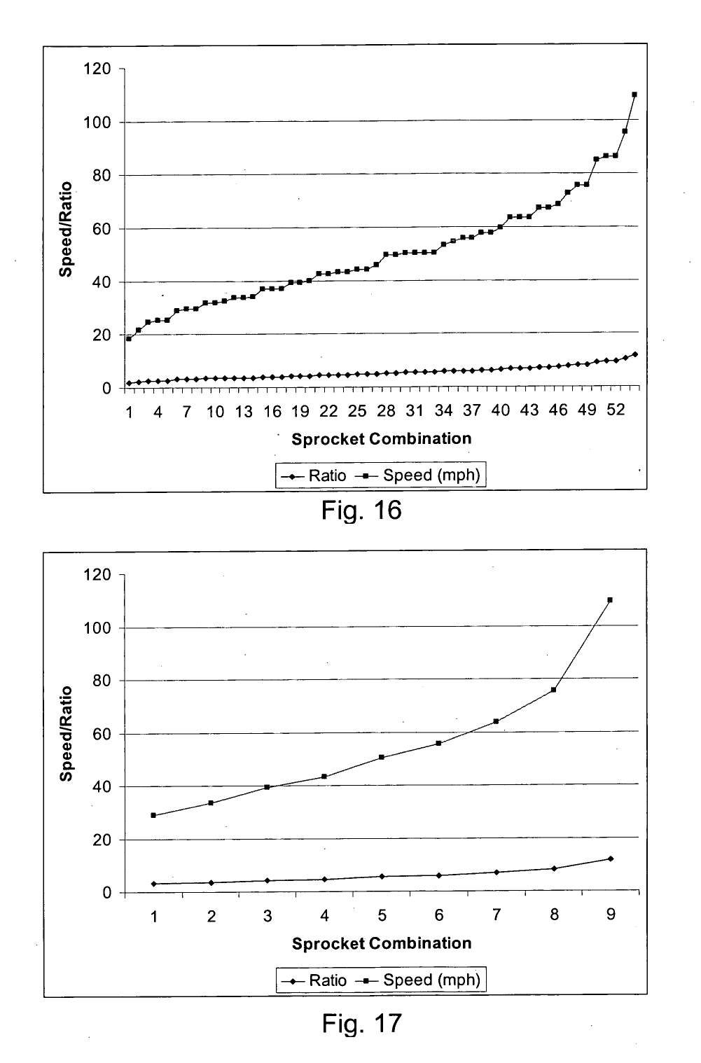

FIG. 16 is a graph illustrating theoretical speed v. sprocket combination for the 54-speed bicycle configuration of Table 11.

FIG. 17 shows a graph illustrating theoretical speed v. sprocket combination for a power transmission system having the first and second sets of user-selectable gearwheels identical to the configuration of Table 11, and the third set fixed on sprocket #6. In this case, the theoretical maximum achievable speed is the same. However, it can be seen in the graph of FIG. 17 that the smaller incremental ratios are not available to the user. Thus, the average ratio step size is high at (11.76−3.11)/9 =0.961.

Table 13 summarizes a configuration of the embodiment of the power transmission system 30 shown in FIG. 2, in which first sprocket set 32 has three user-selectable sprockets, input subset 41 of second sprocket set 40 has a single sprocket, output subset 42 of second sprocket set 40 has three user-selectable sprockets, and third sprocket set 48 has six user-selectable sprockets. The number of selectable sprocket combinations is 54. The number of teeth on the sprockets is different from the embodiments shown above.

TABLE 13

| First Set | | Second Set | | Third Set | |
|---|---|---|---|---|---|
| #1 | 48 teeth | Input | 28 teeth | #1 | 28 teeth |
| #2 | 36 teeth | Output #1 | 48 teeth | #2 | 24 teeth |
| #3 | 24 teeth | Output #2 | 36 teeth | #3 | 21 teeth |
| | | Output #3 | 24 teeth | #4 | 18 teeth |
| | | | | #5 | 16 teeth |
| | | | | #6 | 14 teeth |

Table 14 summarizes the speed ratios and theoretical speeds possible with the 54-speed configuration of Table 13, given a rear wheel outer diameter of 26″, and 80 rpm at the pedals.

TABLE 14

| | # | Second | # | | # | | Speed |
|---|---|---|---|---|---|---|---|
| First Set | Teeth | Set | Teeth | Third Set | Teeth | Ratio | (mph) |
| [symbol] | [symbol] | [symbol] | [symbol] | #1 | 28 | 1:2.94 | 18.19 |
| | | | | #2 | 24 | 1:3.43 | 21.22 |
| | | | | #3 | 21 | 1:3.92 | 24.25 |
| | | | | #4 | 18 | 1:4.57 | 28.29 |
| | | | | #5 | 16 | 1:5.14 | 31.82 |
| | | | | [symbol] | [symbol] | [symbol] | [symbol] |
| | | Output #2 | 36 | #1 | 28 | 1:2.20 | 13.64 |
| | | | | #2 | 24 | 1:2.57 | 15.91 |
| | | | | #3 | 21 | 1:2.94 | 18.19 |
| | | | | #4 | 18 | 1:3.43 | 21.22 |
| | | | | #5 | 16 | 1.3.86 | 23.87 |
| | | | | #6 | 14 | 1:4.41 | 27.28 |
| | | Output #3 | 24 | #1 | 28 | 1:1.47 | 9.09 |
| | | | | #2 | 24 | 1:1.71 | 10.61 |
| | | | | #3 | 21 | 1:1.96 | 12.12 |
| | | | | #4 | 18 | 1:2.29 | 14.14 |
| | | | | #5 | 16 | 1:2.57 | 15.91 |
| | | | | #6 | 14 | 1:2.94 | 18.19 |
| #2 | 36 | Output #1 | 48 | #1 | 28 | 1:2.20 | 13.64 |
| | | | | #2 | 24 | 1:2.57 | 15.91 |
| | | | | #3 | 21 | 1:2.94 | 18.19 |
| | | | | #4 | 18 | 1:3.43 | 21.22 |
| | | | | #5 | 16 | 1:3.86 | 23.87 |
| | | | | #6 | 14 | 1:4.41 | 27.28 |
| | | Output #2 | 36 | #1 | 28 | 1:1.65 | 10.23 |
| | | | | #2 | 24 | 1:1.93 | 11.93 |
| | | | | #3 | 21 | 1:2.20 | 13.64 |
| | | | | #4 | 18 | 1:2.57 | 15.91 |
| | | | | #5 | 16 | 1:2.89 | 17.90 |
| | | | | #6 | 14 | 1:3.31 | 20.46 |
| | | Output #3 | 24 | #1 | 28 | 1:1.10 | 6.82 |
| | | | | #2 | 24 | 1:1.29 | 7.96 |
| | | | | #3 | 21 | 1:1.47 | 9.09 |
| | | | | #4 | 18 | 1:1.71 | 10.61 |
| | | | | #5 | 16 | 1:1.93 | 11.93 |
| | | | | #6 | 14 | 1:2.20 | 13.64 |
| #3 | 24 | Output #1 | 48 | #1 | 28 | 1:1.47 | 9.09 |
| | | | | #2 | 24 | 1:1.71 | 10.61 |
| | | | | #3 | 21 | 1:1.96 | 12.12 |
| | | | | #4 | 18 | 1:2.29 | 14.14 |
| | | | | #5 | 16 | 1:2.57 | 15.91 |
| | | | | #6 | 14 | 1:2.94 | 18.19 |
| | | Output #2 | 36 | #1 | 28 | 1:1.10 | 6.82 |
| | | | | #2 | 24 | 1:1.29 | 7.96 |
| | | | | #3 | 21 | 1:1.47 | 9.09 |
| | | | | #4 | 18 | 1:1.71 | 10.61 |
| | | | | #5 | 16 | 1:1.93 | 11.93 |
| | | | | #6 | 14 | 1:2.20 | 13.64 |
| | | Output #3 | 24 | #1 | 28 | 1:0.73 | 4.55 |
| | | | | #2 | 24 | 1:0.86 | 5.30 |
| | | | | #3 | 21 | 1:0.98 | 6.06 |
| | | | | #4 | 18 | 1:1.14 | 7.07 |
| | | | | #5 | 16 | 1:1.29 | 7.96 |
| | | | | #6 | 14 | 1:1.47 | 9.09 |

As can be seen, with the configuration of Table 13, where a rpm of 80 is achieved by the user, a maximum theoretical speed of 36.37 miles per hour is possible, with 54 selectable combinations of sprockets, yielding 24 unique ratios from 0.73 to 5.88. Thus, the average ratio step size is (5.88−0.73)/24=0.215.

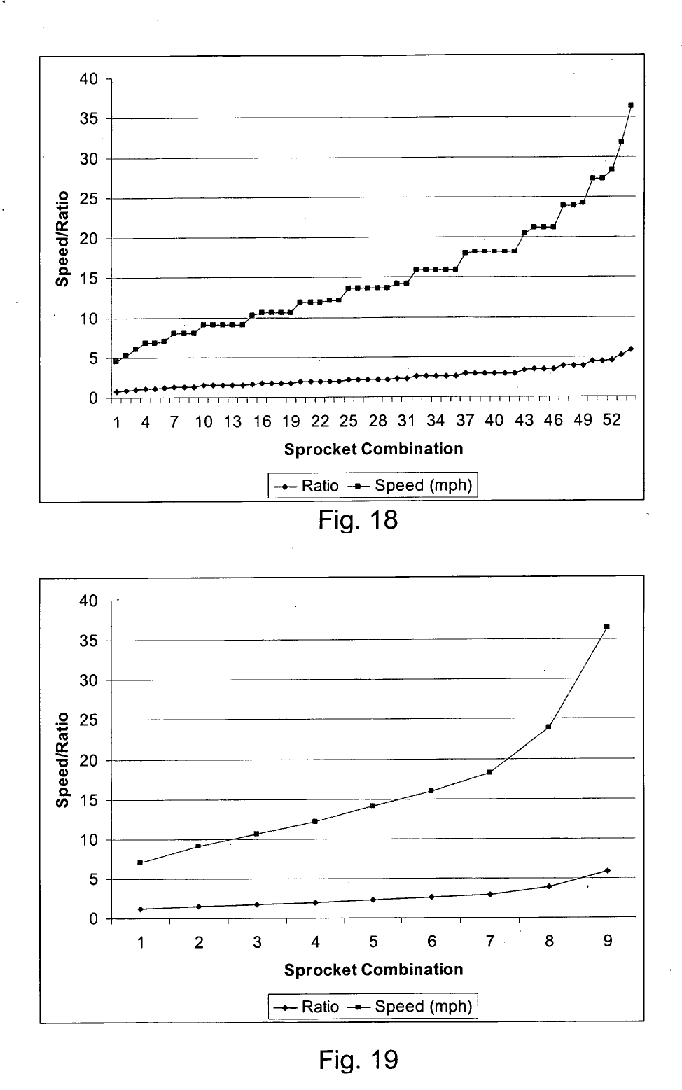

FIG. 18 is a graph illustrating theoretical speed v. sprocket combination for the 54-speed bicycle configuration of Table 13.

FIG. 19 shows a graph illustrating theoretical speed v. sprocket combination for a power transmission system having the first and second sets of user-selectable gearwheels identical to the configuration of Table 13, and the third set fixed on sprocket #6. In this case, the theoretical maximum achievable speed is the same. However, it can be seen in the graph of FIG. 19 that the smaller incremental ratios are not available to the user. Thus, the average ratio step size is high at (5.88−1.14)/9 =0.527.

Table 15 summarizes a configuration of the embodiment of the power transmission system 30 shown in FIG. 2, in which first sprocket set 32 has three user-selectable sprockets, input subset 41 of second sprocket set 40 has a single sprocket, output subset 42 of second sprocket set 40 has three user-selectable sprockets, and third sprocket set 48 has six user-selectable sprockets. The number of selectable sprocket combinations is 54. This configuration is similar to that shown in Table 13, except that the input sprocket on the second set has 14, instead of 28 teeth.

TABLE 15

| First Set | | Second Set | | Third Set | |
|---|---|---|---|---|---|
| #1 | 48 teeth | Input | 14 teeth | #1 | 28 teeth |
| #2 | 36 teeth | Output #1 | 48 teeth | #3 | 24 teeth |
| #3 | 24 teeth | Output #2 | 36 teeth | #4 | 21 teeth |
| | | Output #3 | 24 teeth | #4 | 18 teeth |
| | | | | #5 | 16 teeth |
| | | | | #6 | 14 teeth |

Table 16 summarizes the speed ratios and theoretical speeds possible with the 54-speed configuration of Table 15, given a rear wheel outer diameter of 26″, and 80 rpm at the pedals.

TABLE 16

| | # | Second | # | | # | | Speed |
|---|---|---|---|---|---|---|---|
| First Set | Teeth | Set | Teeth | Third Set | Teeth | Ratio | (mph) |
| [symbol] | [symbol] | [symbol] | [symbol] | #1 | 28 | 1:5.88 | 36.37 |
| | | | | #2 | 24 | 1:6.86 | 42.43 |
| | | | | #3 | 21 | 1:7.84 | 48.49 |
| | | | | #4 | 18 | 1:9.14 | 56.58 |
| | | | | #5 | 16 | 1:10.29 | 63.65 |
| | | | | [symbol] | [symbol] | [symbol] | [symbol] |
| | | Output #2 | 36 | #1 | 28 | 1:4.41 | 27.28 |
| | | | | #2 | 24 | 1:5.14 | 31.82 |
| | | | | #3 | 21 | 1:5.88 | 36.37 |
| | | | | #4 | 18 | 1:6.86 | 42.43 |
| | | | | #5 | 16 | 1:7.71 | 47.74 |
| | | | | #6 | 14 | 1:8.82 | 54.56 |
| | | Output #3 | 24 | #1 | 28 | 1:2.94 | 18.19 |
| | | | | #2 | 24 | 1:3.43 | 21.22 |
| | | | | #3 | 21 | 1:3.92 | 24.25 |
| | | | | #4 | 18 | 1:4.57 | 28.29 |
| | | | | #5 | 16 | 1:5.14 | 31.82 |
| | | | | #6 | 14 | 1:5.88 | 36.37 |
| #2 | 36 | Output #1 | 48 | #1 | 28 | 1:4.41 | 27.28 |
| | | | | #2 | 24 | 1:5.14 | 31.82 |
| | | | | #3 | 21 | 1:5.88 | 36.37 |
| | | | | #4 | 18 | 1:6.86 | 42.43 |
| | | | | #5 | 16 | 1:7.71 | 47.74 |
| | | | | #6 | 14 | 1:8.82 | 54.56 |
| | | Output #2 | 36 | #1 | 28 | 1:3.31 | 20.46 |
| | | | | #2 | 24 | 1:3.86 | 23.87 |
| | | | | #3 | 21 | 1:4.41 | 27.28 |
| | | | | #4 | 18 | 1:5.14 | 31.82 |
| | | | | #5 | 16 | 1:5.79 | 35.80 |
| | | | | #6 | 14 | 1:6.61 | 40.92 |
| | | Output #3 | 24 | #1 | 28 | 1:2.20 | 13.64 |
| | | | | #2 | 24 | 1:2.57 | 15.91 |
| | | | | #3 | 21 | 1:2.94 | 18.19 |
| | | | | #4 | 18 | 1:3.43 | 21.22 |
| | | | | #5 | 16 | 1:3.86 | 23.87 |
| | | | | #6 | 14 | 1:4.41 | 27.28 |
| #3 | 24 | Output #1 | 48 | #1 | 28 | 1:2.94 | 18.19 |
| | | | | #2 | 24 | 1:3.43 | 21.22 |
| | | | | #3 | 21 | 1:3.92 | 24.25 |
| | | | | #4 | 18 | 1:4.57 | 28.29 |
| | | | | #5 | 16 | 1:5.14 | 31.82 |
| | | | | #6 | 14 | 1:5.88 | 36.37 |
| | | Output #2 | 36 | #1 | 28 | 1:2.20 | 13.64 |
| | | | | #2 | 24 | 1:2.57 | 15.91 |
| | | | | #3 | 21 | 1:2.94 | 18.19 |
| | | | | #4 | 18 | 1:3.43 | 21.22 |
| | | | | #5 | 16 | 1:3.86 | 23.87 |
| | | | | #6 | 14 | 1:4.41 | 27.28 |
| | | Output #3 | 24 | #1 | 28 | 1:1.47 | 9.09 |
| | | | | #2 | 24 | 1:1.71 | 10.61 |
| | | | | #3 | 21 | 1:1.96 | 12.12 |
| | | | | #4 | 18 | 1:2.29 | 14.14 |
| | | | | #5 | 16 | 1:2.57 | 15.91 |
| | | | | #6 | 14 | 1:2.94 | 18.19 |

As can be seen, with the configuration of Table 15, where a rpm of 80 is achieved by the user, a maximum theoretical speed of 72.74 miles per hour is possible, with 54 selectable combinations of sprockets, yielding 24 unique ratios from 1.47 to 11.76. Thus, the average ratio step size is (11.76−1.47)/24=0.429.

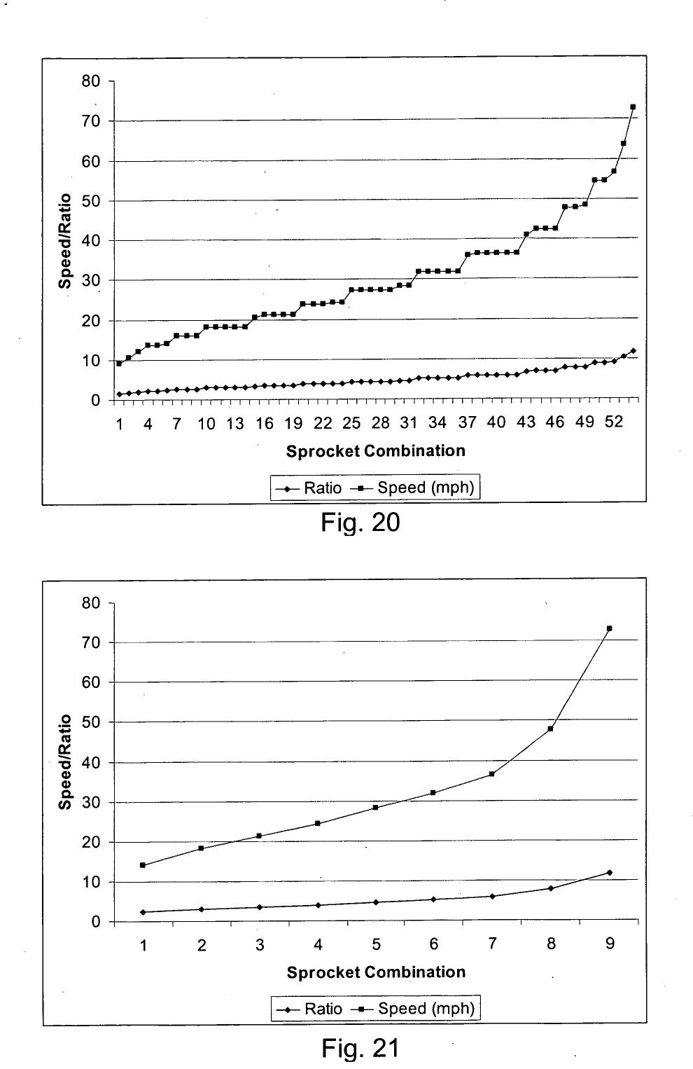

FIG. 20 is a graph illustrating theoretical speed v. sprocket combination for the 54-speed bicycle configuration of Table 15.

FIG. 21 shows a graph illustrating theoretical speed v. sprocket combination for a power transmission system having the first and second sets of user-selectable gearwheels identical to the configuration of Table 15, and the third set fixed on sprocket #6. In this case, the theoretical maximum achievable speed is the same. However, it can be seen in the graph of FIG. 21 that the smaller incremental ratios are not available to the user. Thus, the average ratio step size is high at (11.76−2.29)/9=1.05.

Table 17 summarizes a configuration of the embodiment of the power transmission system 30 shown in FIG. 2, in which first sprocket set 32 has three user-selectable sprockets, input subset 41 of second sprocket set 40 has a single sprocket, output subset 42 of second sprocket set 40 has three user-selectable sprockets, and third sprocket set 48 has six user-selectable sprockets. The number of selectable sprocket combinations is 54.

TABLE 17

| First Set | | Second Set | | Third Set | |
|---|---|---|---|---|---|
| #1 | 48 teeth | Input | 14 teeth | #1 | 28 teeth |
| #2 | 38 teeth | Output #1 | 48 teeth | #2 | 24 teeth |
| #3 | 28 teeth | Output #2 | 38 teeth | #3 | 21 teeth |
| | | Output #3 | 28 teeth | #4 | 18 teeth |
| | | | | #5 | 16 teeth |
| | | | | #6 | 14 teeth |

Table 18 summarizes the speed ratios and theoretical speeds possible with the 54-speed configuration of Table 17, given a rear wheel outer diameter of 26″, and 100 rpm at the pedals.

TABLE 18

| | # | Second | # | | # | | Speed |
|---|---|---|---|---|---|---|---|
| First Set | Teeth | Set | Teeth | Third Set | Teeth | Ratio | (mph) |
| [symbol] | [symbol] | [symbol] | [symbol] | #1 | 28 | 1:5.88 | 45.46 |
| | | | | #2 | 24 | 1:6.86 | 53.04 |
| | | | | #3 | 21 | 1:7.84 | 60.62 |
| | | | | #4 | 18 | 1:9.14 | 70.72 |
| | | | | #5 | 16 | 1:10.29 | 79.56 |
| | | | | [symbol] | [symbol] | [symbol] | [symbol] |
| | | Output #2 | 38 | #1 | 28 | 1:4.65 | 35.99 |
| | | | | #2 | 24 | 1:5.43 | 41.99 |
| | | | | #3 | 21 | 1:6.20 | 47.99 |
| | | | | #4 | 18 | 1:7.24 | 55.99 |
| | | | | #5 | 16 | 1:8.14 | 62.98 |
| | | | | #6 | 14 | 1:9.31 | 71.98 |
| | | Output #3 | 28 | #1 | 28 | 1:3.43 | 26.52 |
| | | | | #2 | 24 | 1:4.00 | 30.94 |
| | | | | #3 | 21 | 1:4.57 | 35.36 |
| | | | | #4 | 18 | 1:5.33 | 41.25 |
| | | | | #5 | 16 | 1:6.00 | 46.41 |
| | | | | #6 | 14 | 1:6.86 | 53.04 |
| #2 | 38 | Output #1 | 48 | #1 | 28 | 1:4.65 | 35.99 |
| | | | | #2 | 24 | 1:5.43 | 41.99 |
| | | | | #3 | 21 | 1:6.20 | 47.99 |
| | | | | #4 | 18 | 1:7.24 | 55.99 |
| | | | | #5 | 16 | 1:8.14 | 62.98 |
| | | | | #6 | 14 | 1:9.31 | 71.98 |
| | | Output #2 | 38 | #1 | 28 | 1:3.68 | 28.49 |
| | | | | #2 | 24 | 1:4.30 | 33.24 |
| | | | | #3 | 21 | 1:4.91 | 37.99 |
| | | | | #4 | 18 | 1:5.73 | 44.32 |
| | | | | #5 | 16 | 1:6.45 | 49.86 |
| | | | | #6 | 14 | 1:7.37 | 56.99 |
| | | Output #3 | 28 | #1 | 28 | 1:2.71 | 20.99 |
| | | | | #2 | 24 | 1:3.17 | 24.49 |
| | | | | #3 | 21 | 1:3.62 | 27.99 |
| | | | | #4 | 18 | 1:4.22 | 32.66 |
| | | | | #5 | 16 | 1:4.75 | 36.74 |
| | | | | #6 | 14 | 1:5.43 | 41.99 |
| #3 | 28 | Output #1 | 48 | #1 | 28 | 1:3.43 | 26.52 |
| | | | | #2 | 24 | 1:4.00 | 30.94 |
| | | | | #3 | 21 | 1:4.57 | 35.36 |
| | | | | #4 | 18 | 1:5.33 | 41.25 |
| | | | | #5 | 16 | 1:6.00 | 46.41 |
| | | | | #6 | 14 | 1:6.86 | 53.04 |
| | | Output #2 | 38 | #1 | 28 | 1:2.71 | 20.99 |
| | | | | #2 | 24 | 1:3.17 | 24.49 |
| | | | | #3 | 21 | 1:3.62 | 27.99 |
| | | | | #4 | 18 | 1:4.22 | 32.66 |
| | | | | #5 | 16 | 1:4.75 | 36.74 |
| | | | | #6 | 14 | 1:5.43 | 41.99 |
| | | Output #3 | 28 | #1 | 28 | 1:2.00 | 15.47 |
| | | | | #2 | 24 | 1:2.33 | 18.05 |
| | | | | #3 | 21 | 1:2.67 | 20.63 |
| | | | | #4 | 18 | 1:3.11 | 24.06 |
| | | | | #5 | 16 | 1:3.50 | 27.07 |
| | | | | #6 | 14 | 1:4.00 | 30.94 |

As can be seen, with the configuration of Table 17, where a rpm of 100 is achieved by the user, a maximum theoretical speed of 90.93 miles per hour is possible, with 54 selectable combinations of sprockets, yielding 32 unique ratios from 2.00 to 11.76. Thus, the average ratio step size is (11.76−2.00)/32=0.305.

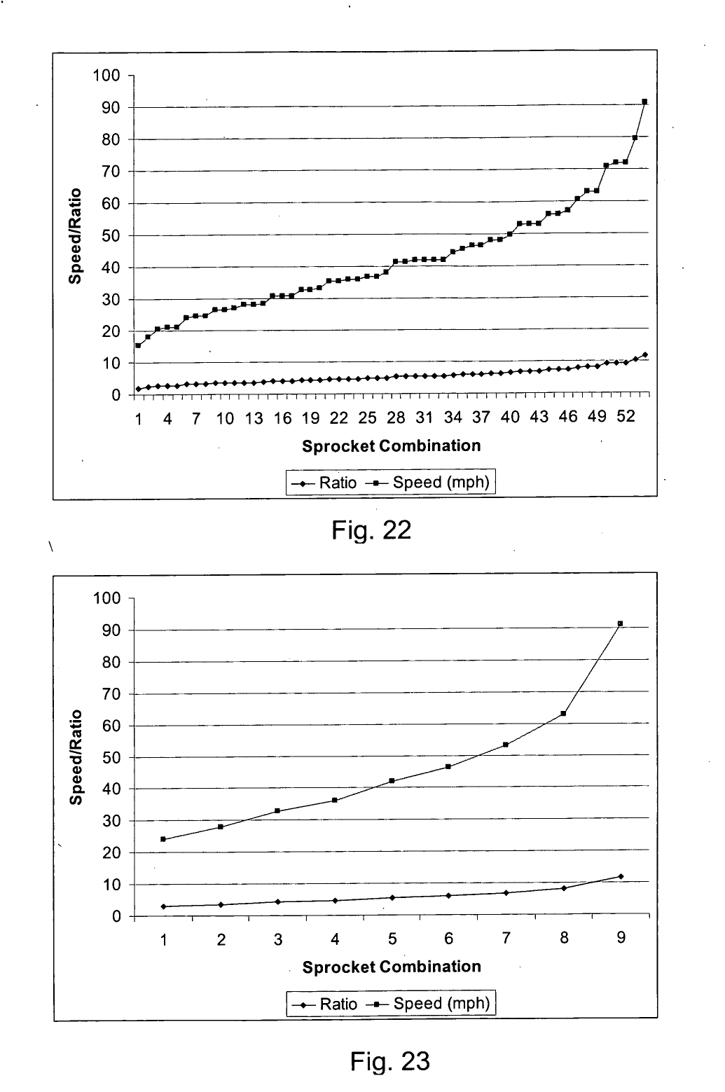

FIG. 22 is a graph illustrating theoretical speed v. sprocket combination for the 54-speed bicycle configuration of Table 17.

FIG. 23 shows a graph illustrating theoretical speed v. sprocket combination for a power transmission system having the first and second sets of user-selectable gearwheels identical to the configuration of Table 17, and the third set fixed on sprocket #6. In this case, the theoretical maximum achievable speed is the same. However, it can be seen in the graph of FIG. 23 that the smaller incremental ratios are not available to the user. Thus, the average ratio step size is high at (11.76−3.11)/9 =0.961

The particular sprocket selector switches used to move the derailleurs as required may be any sort compatible with the particular derailleurs employed. Cable and cable sheath connections between the sprocket selector switches and respective derailleurs would be routed along or within frame 60 as would be known. For example, the cable and cable sheath connecting a gear selector switch with second sprocket set 40 could be routed along the frame from handle bars 14, along upper rearward extension 70 to subextension 74 in order to connect with input derailleur 44 or output derailleur 45.

The mechanisms that allow the rear wheel to turn freely during downhill coasting, those that provide braking action/control and other such considerations are considered within the scope of understanding of a person skilled in bicycle construction, design, and maintenance.

While particular embodiments of the invention have been described, it will be understood that other embodiments may be conceived that are within the scope and purpose of the invention.

For example, while the first set of user-selectable sprockets has been shown to be directly connected to the pedal/crank combination, it will be understood that the first set of user-selectable sprockets may receive rotational power directly from another means or, for example, from an additional crank-powered sprocket set via an additional chain. Alternatively, or even in combination, the third set of user-selectable sprockets may not be co-axial with the driven wheel, but rather connected by chain to an additional sprocket co-axial with the driven wheel. It will be understood that receipt of power from an additional, unselectable sprocket may serve to amplify the power output without accordingly providing for a desirably low average mechanical ratio step size. The invention, however, would advantageously serve to reduce the average ratio step size.

Furthermore, additional intermediate sprocket sets in the sequence may be provided, having respective input and output subsets of sprockets, one or both of which may comprise multiple user-selectable sprockets.

Sprockets, chains and chain derailleurs are common parts which may be combined with minimum modification to achieve the objects of the invention. However, it may be contemplated to use alternative gearwheels such as pulleys, alternative gearwheel selection means, and alternative interconnection means such as different types of chains without departing from the spirit and scope of the invention described herein.

Particular combinations of sprockets have been disclosed, but it will occur to the designer of a bicycle or other personal transportation device having a power transmission system to select combinations of sprockets yielding different teeth number combinations that achieve the desired theoretical maximum speed and provide a sufficiently low mechanical ratio step size through the speed range.

A particular frame configuration has been shown in which the upper rearward extension, lower rearward extension, and base are formed as a single piece. However, it may be contemplated to form each or some as a single piece in order to facilitate manufacture, or otherwise to cater to a particular aftermarket where applicable.

The power transmission system has been described for application in a bicycle. However, it will be contemplated that the invention could be employed in other, similar personal transportation devices such as multiple-speed tricycles. In the case of the tricycle, the third sprocket set could have an elongated common axle with two rear wheels.

Other alternatives may be contemplated by those of ordinary skill in the art and it will be appreciated that variations and modifications may be made without departing from the spirit and scope thereof as defined by the appended claims.

What is claimed is:

1. A power transmission system for a wheeled personal transportation device, comprising:
a sequence of at least three operably interconnected sets of gearwheels, a first set in the sequence for receiving rotational force and a last set in the sequence for transmitting rotational force for a driven wheel of the device, the first set and the last set each comprising user-selectable gearwheels;
at least one intermediate set in the sequence comprising an input gearwheel subset and an output gearwheel subset, at least one of the input gearwheel subset and the output gearwheel subset comprising a plurality of user-selectable gearwheels.

2. The power transmission system of claim 1, wherein the sets of gearwheels are operably interconnected with chains.

3. The power transmission system of claim 1, wherein a crank/pedal assembly provides rotational force to the first set.

4. The power transmission system of claim 3, wherein the last set is co-axial with the driven wheel of the device.

5. The power transmission system of claim 2, wherein the gearwheels in the gearwheel sets are sprockets.

6. The power transmission system of claim 5, wherein the gearwheels are user-selectable by derailleur.

7. The power transmission system of claim 6, wherein at least one derailleur keeps the chains connected to respective ones of the input and output gearwheel subsets from directly contacting one another.

8. The power transmission system of claim 7, wherein both the input gearwheel subset and output gearwheel subset comprise a plurality of user-selectable gearwheels.

9. The power transmission system of claim 8, wherein derailleurs are associated with each of the input gearwheel subset and the output gearwheel subset.

10. A power transmission system for a wheeled personal transportation device, comprising:
a first set of user-selectable gearwheels for receiving rotational force;
a second set of gearwheels comprising an input gearwheel subset operably interconnected with the first set, and an output gearwheel subset, at least one of the input gearwheel subset and the output gearwheel subset comprising a plurality of user-selectable gearwheels; and
a third set of user-selectable gearwheels operably interconnected with the output gearwheel subset for transmitting rotational force for a driven wheel of the device.

11. The power transmission system of claim 10, wherein the gearwheels are sprockets.

12. The power transmission system of claim 11, wherein there are three user-selectable gearwheels in the first set.

13. The power transmission system of claim 12, wherein the three user-selectable gearwheels in the first set have, respectively, 48 teeth, 38 teeth, and 28 teeth.

14. The power transmission system of claim 12, wherein the three user-selectable gearwheels in the first set have, respectively, 48 teeth, 36 teeth, and 24 teeth.

15. The power transmission system of claim 13, wherein there are two user-selectable gearwheels in the input gearwheel subset.

16. The power transmission system of claim 15, wherein the two user-selectable gearwheels in the input gearwheel subset have, respectively, 14 teeth, and 16 teeth.

17. The power transmission system of claim 16, wherein the output gearwheel subset comprises one gearwheel.

18. The power transmission system of claim 17, wherein the one gearwheel in the input gearwheel subset has one of 28 teeth, 38 teeth, and 48 teeth.

19. The power transmission system of claim 18, wherein there are six user-selectable gearwheels in the third set.

20. The power transmission system of claim 19, wherein the six user-selectable gearwheels in the third set have, respectively, 28 teeth, 24 teeth, 21 teeth, 18 teeth, 16 teeth, and 14 teeth.

21. The power transmission system of claim 13, wherein there are three user-selectable gearwheels in the output gearwheel subset.

22. The power transmission system of claim 21, wherein the three user-selectable gearwheels in the output gearwheel subset have, respectively, 48 teeth, 38 teeth, and 28 teeth.

23. The power transmission system of claim 21, wherein the three user-selectable gearwheels in the output gearwheel subset have, respectively, 48 teeth, 36 teeth, and 24 teeth.

24. The power transmission system of claim 22, wherein the input gearwheel subset comprises one gearwheel.

25. The power transmission system of claim 24, wherein the one gearwheel in the input gearwheel subset has 14 teeth.

26. The power transmission system of claim 24, wherein the one gearwheel in the input gearwheel subset has 28 teeth.

27. The power transmission system of claim 25, wherein there are six user-selectable gearwheels in the third set.

28. The power transmission system of claim 27, wherein the six user-selectable gearwheels in the third set have, respectively, 28 teeth, 24 teeth, 21 teeth, 18 teeth, 16 teeth, and 14 teeth.

29. A frame for a personal transportation device, comprising:
a base;
a steering shaft on the base for supporting a steering column;
crank connection means on the base for operably receiving a crank/pedal combination and an associated first set of user-selectable gearwheels;
an upper-rearward extension extending from a rear of the base for operably receiving a second set of gearwheels comprising an input gearwheel subset and an output gearwheel subset, at least one of the input gearwheel subset and the output gearwheel subset comprising a plurality of user-selectable gearwheels;
a subextension associated with the upper-rearward extension for supporting a gearwheel-change mechanism associated with a respective one of the output gearwheel subset and the input gearwheel subset;
a lower-rearward extension extending from the rear of the base for supporting the driven wheel and a rotatable third set of gearwheels.

30. The frame of claim 29, wherein the at least one gearwheel-change mechanism is a derailleur for shifting a chain between gearwheels.

31. The frame of claim 30, wherein both of the input gearwheel subset and the output gearwheel subset comprise respective pluralities of user-selectable gearwheels, and the subextension is also for supporting a second gearwheel-change mechanism associated with the other of the input gearwheel subset and the output gearwheel subset.

32. The frame of claim 29, wherein both of the input gearwheel subset and the output gearwheel subset comprise a plurality of user-selectable gearwheels, the frame further comprising:
a second subextension associated with the upper-rearward extension for supporting a second gearwheel-change mechanism associated with the other one of the input gearwheel subset and the output gearwheel subset.
